(19) United States
(12) Patent Application Publication
(10) Pub. No.: US 2010/0199503 A1
(43) Pub. Date: Aug. 12, 2010

(54) POWER LINE CUTTER

(76) Inventor: Pat Lorenson, O'Fallon, MO (US)

Correspondence Address: POLSINELLI SHUGHART PC, 700 W. 47TH STREET, SUITE 1000, KANSAS CITY, MO, 64112-1802, US

(21) Appl. No.: 12/369,526

(22) Filed: Feb. 11, 2009

(51) Int. Cl. B26B 17/02

(52) U.S. Cl. 30/251

(57) ABSTRACT

A power line cutter is described. The power line cutter may be used in emergency or repair situations to cut down or broken power lines. The power line cutter is provided with a long extension handle such that the operator may use the power line cutter to cut power lines hanging or suspended above the operator.

The power line cutter includes a first blade having a first blade cutting surface and a first blade lever. The power line cutter further includes a second blade having a second blade cutting surface and a second blade lever. A first handle is pivotally engaged to the first blade, and the first handle includes a first pulley. A second handle is pivotally engaged to the second blade, and the second handle includes a second pulley. The first handle is pivotally engaged to the second handle. A blade support is pivotally engaged to the first blade and to the second blade to pivotally position the first blade cutting surface opposite of the second blade cutting surface. A line passes from the first handle to the second pulley. The line further passes to the first pulley. A bracket extends from the blade support and the bracket connects or attaches to an extension.

### FIELD OF INVENTION

The present invention relates to a power line cutter for cutting electrical power lines.

### SUMMARY OF INVENTION

A power line cutter is herein described. The power line cutter may be used in emergency or repair situations to cut down or broken power lines. The power line cutter may be provided with a stick or a long extension handle such that the operator may use the power line cutter to cut power lines hanging or suspended above the operator. The stick or the extension handle may include a universal spline attachment.

The power line cutter herein described provides many advantages over other existing wire and power line cutters. The power line cutter replaces the need for the operator to climb an electrical pole or to utilize a bucket-lift or cherry picker type crane in order to be raised to a height sufficient to access the down or broken power lines. By eliminating the need for a crane or lift, money, labor and expenses are saved. By eliminating the need for a climb, safety and efficiency are improved.

The power line cutter herein described has its cutting surfaces facing in an upright direction, such that the power line to be cut may be easily accessed from below the power line or from an operator on the ground. Other existing wire cutters require that the cutting surface be placed over a top surface the wire, such that the cutting surface of the existing wire cutter is facing toward the ground. Such an orientation for the existing wire cutter may prove difficult for the operator to achieve. This is especially true when the power line is angled toward the ground, for example, when a broken power line is dangling or hanging.

Also, many existing wire cutters and power line cutters only utilize one moving handle or lever to actuate the cutting surface or surfaces. This arrangement requires significant strength on the part of the operator actuating the device. The power line cutter herein described provides improved mechanical advantage and a more efficient design that provides sufficient shearing force to cut powerlines without the difficult actuation required of existing devices.

The power line cutter comprises a first blade comprising a first blade cutting surface and a first blade lever. The power line cutter further comprises a second blade comprising a second blade cutting surface and a second blade lever. A first handle is pivotally engaged to the first blade, and the first handle comprises a first pulley. A second handle is pivotally engaged to the second blade, and the second handle comprises a second pulley. The first handle is pivotally engaged to the second handle. A blade support is pivotally engaged to the first blade and to the second blade to pivotally position the first blade cutting surface opposite of the second blade cutting surface. A line passes from the first handle to the second pulley. The line further passes to the first pulley. A bracket extends from the blade support and the bracket connects or attaches to an extension.

During operation of the power line cutter, an operator guides the power line cutter to the power line and positions the power line between the first blade cutting surface and the second blade cutting surface. Then, the operator pulls on the line, which squeezes both handles together via the pulleys, and thus actuates the first blade cutting surface and the second blade cutting surface to compress and shear the power line. When the operator pulls on the line, both of the handles move toward each other.

The first and second blade levers are fitted with one or more springs to force the blades to an open position when the line is not pulled, such that the power line may easily fit into the opening between the first blade cutting surface and the second blade cutting surface. Also, by use of the springs, the first and second blade cutting surfaces are automatically in the open and ready position without the operator having to move the handles to open the cutting surfaces.

### BRIEF DESCRIPTION OF THE DRAWINGS

FIG. 1 is a view of the operator cutting the power line with the power line cutter.

FIG. 2 is a rear, perspective view of the power line cutter.

FIG. 3 is a rear view of the power line cutter.

FIG. 4 is a left view of the power line cutter.

FIG. 5 is a right view of the power line cutter.

FIG. 6 is a front, open view of the power line cutter.

FIG. 7 is a front, closed view of the power line cutter.

### DETAILED DESCRIPTION

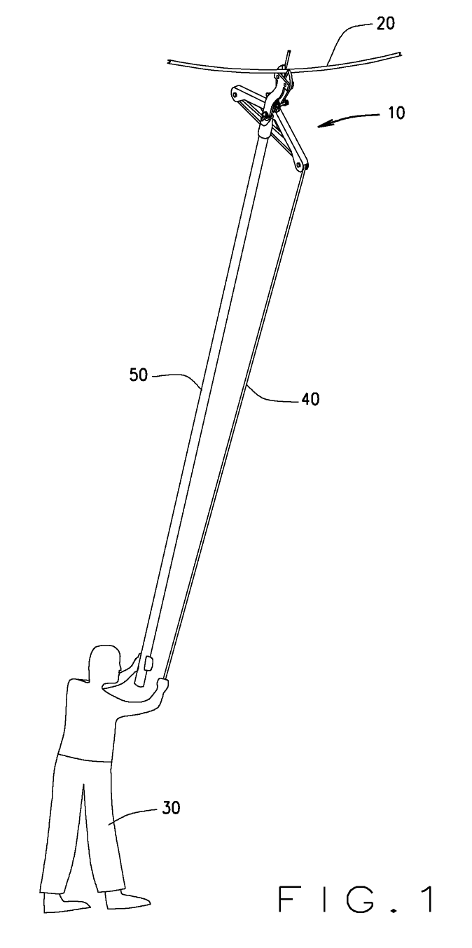

The power line cutter will now be described with reference to FIGS. 1-7. With reference to FIG. 1, a power line cutter 10 is shown. The power line cutter 10 is shown being used by an operator 30 to cut a power line 20. The operator 30 holds the power line cutter 10 via an extension or stick 50 attached or connected to the power line cutter 10. The operator 30 pulls on a line 40 to actuate the power line cutter 10 to cut the power line 20.

The extension or stick 50 may include a short, hand-held version of approximately one or two feet or less in length or a much longer version of up to approximately five feet to approximately forty-five feet in length. The extension or stick 50 may include a telescoping or extendable design. The extension 50 is preferably made of a light-weight, non-electrically-conductive material such as fiberglass or other rigid plastic material that is strong enough to support the power line cutter 10. The extension 50 has an elongated or linear shape in order to reach the elevated power line 20. The line 40 should preferably be at least as long or slightly longer than the extension 50 in order for the operator 30 to conveniently pull on the line 40 to actuate the power line cutter 10. The line 40 may be made of a polyester, cotton, synthetic blends, nylon, etc.

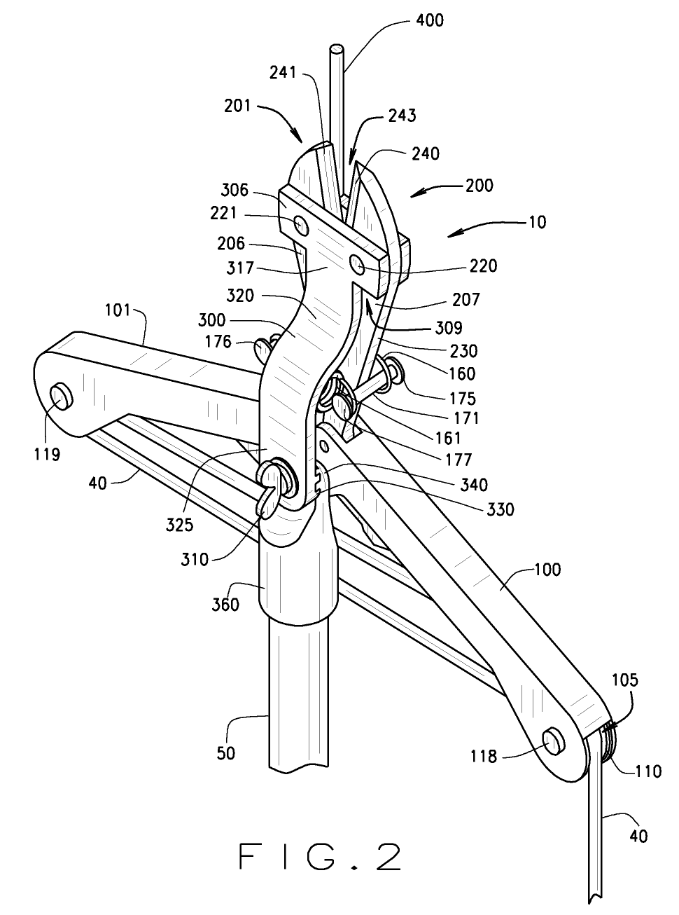

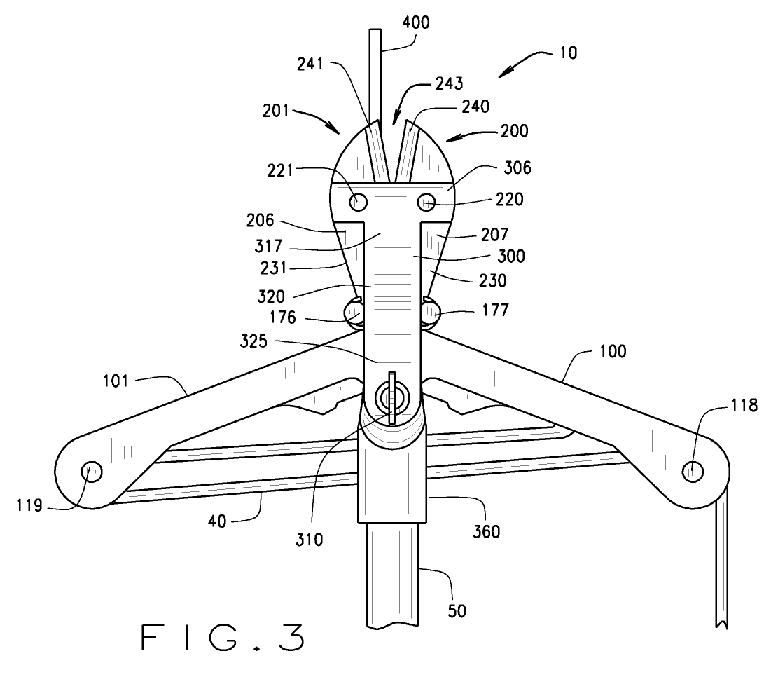

With reference to FIGS. 2 and 3, the power line cutter 10 includes a first blade 200 and a second blade 201. The first blade 200 includes a first blade cutting surface 240 opposite a first blade lever 230. The second blade 201 includes a second blade cutting surface 241 opposite a second blade lever 231. Generally, the first blade cutting surface 240 and the first blade lever 230 are integral portions of the first blade 200, and the second blade cutting surface 241 and the second blade lever 231 are integral portions of the second blade 201. The power line cutter 10 positions the first blade cutting surface 240 opposite the second blade cutting surface 241 such that the cutting surfaces 240 and 241 are forced to a closed position by the blade levers 230 and 231 in a cutting or shearing movement.

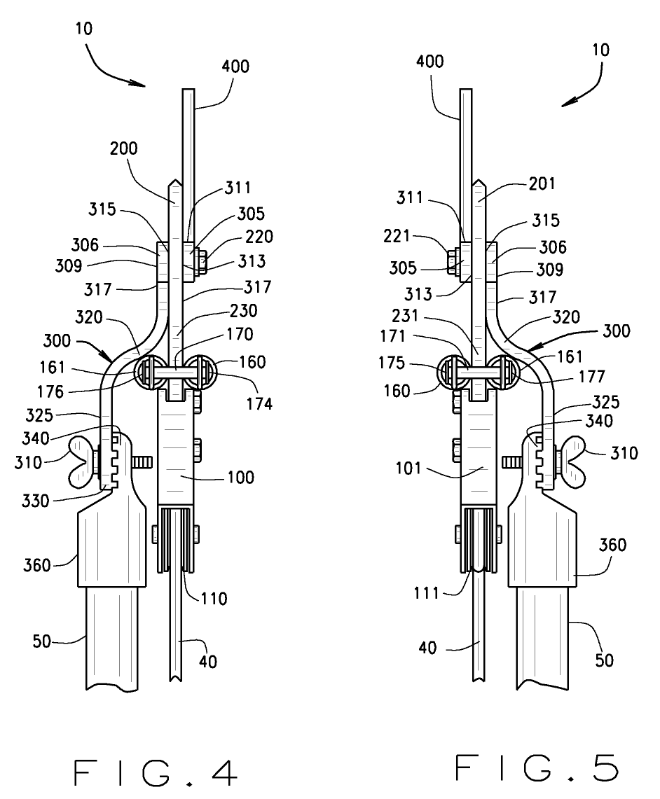

With references to FIGS. 4 and 5, the first blade 200 and the second blade 201 are pivotally engaged to a first blade support 305 and a second blade support 306. The first blade support 305 and the second blade support 306 are positioned on opposite sides of the first blade 200 and the second blade 201. The first blade 200 is pivotally engaged to the first blade support 305 and the second blade support 306 at a first blade fulcrum 220. The second blade 201 is pivotally engaged to the first blade support 305 and the second blade support 306 at second blade fulcrum 221. The first and second blade fulcrums 220 and 221 include an axle, such as a bolt, screw, or rod held or affixed to or into the first and second blade supports 305 and 306 and the first and second blades 200 and 201 in a rotating or pivoting engagement. The first and second blade fulcrums 220 and 221 are positioned on opposite sides of the first and second blade supports 305 and 306. The first blade 200 and the second blade 201 pivot about the first blade fulcrum 220 and the second blade fulcrum 221, respectively, as force is applied to the first blade lever 230 and the second blade lever 231. The first blade 200 and the second blade 201 include an opening or recess to operatively engage the blade supports 305 and 306 and the blade fulcrums 220 and 221.

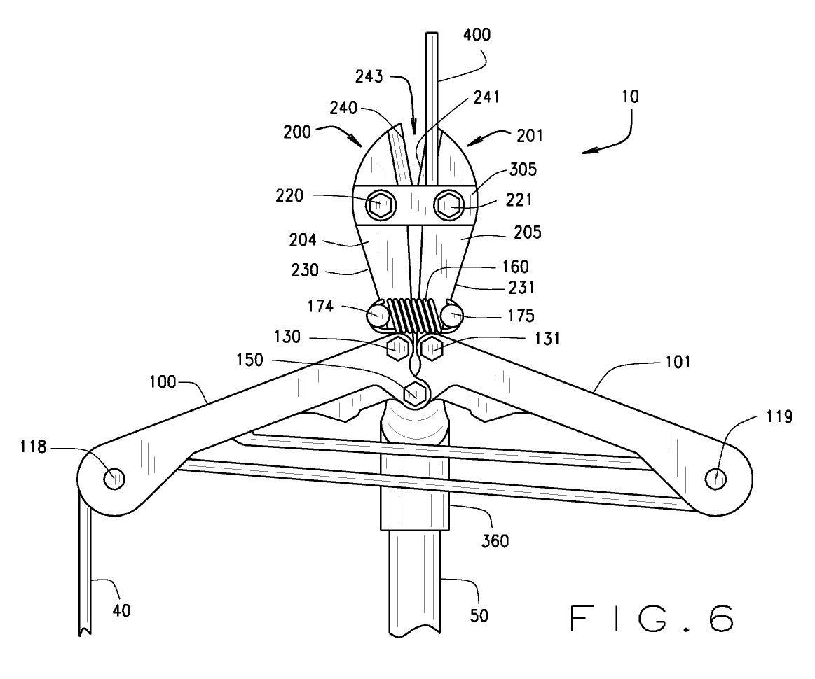

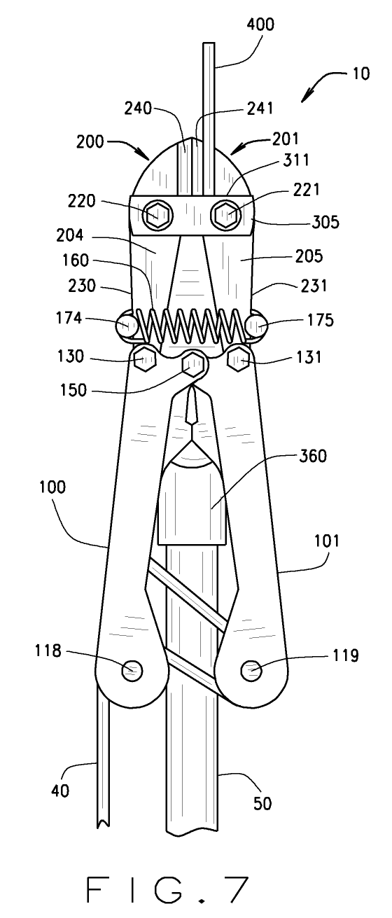

With references to FIGS. 6 and 7, the first blade lever 230 is also pivotally engaged to a first handle 100 at a first blade/handle pivot 130. The second blade lever 231 is also pivotally engaged to a second handle 101 at a second blade/handle pivot 131. As such, the blade lever 230 pivots at the first blade/handle pivot 130 and at the first blade fulcrum 220, while the second blade lever 231 pivots at the second blade/handle pivot 131 and at the second blade fulcrum 221. The first handle 100 and the second handle 101 are also pivotally engaged at a handle pivot 150. The handles 100 and 101 transfer the pulling force on the line 40 to the first blade 200 and to the second blade 201, respectively. The blade levers 230 and 231, under the force of the handles 100 and 101, pivot about the blade fulcrums 220 and 221 resulting in the blade cutting surfaces 240 and 241 moving toward each other in a shearing action. The ends of the blade levers 230 and 231 at the blade/handle pivots 130 and 131 move away from each other under the force of the handle 100 and 101.

A first spring 160 and a second spring 161 provide an opening force to the first blade lever 230 and to the second blade lever 231 to maintain the first blade cutting surface 240 and the second blade cutting surface 241 in an open position. The opening force provided by the springs 160 and 161 is easily over come by the force of the handles 100 and 101 when the line 40 is pulled. With the cutting surfaces 240 and 241 in an open or “ready to cut” position, it is easier for the operator 30 to guide the power line 20 into an opening 243 between the cutting surfaces 240 and 241.

The first blade cutting surface 240 is a sharpened, generally straight portion of the blade 200, while the second blade cutting surface 241 is a sharpened, generally straight portion of the second blade 201. When the handles 100 and 101 move toward each other as the line 40 is pulled, the cutting surfaces 240 and 241 are urged to a closed position by the blade levers 230 and 231 of the blades 200 and 201. As the cutting surfaces 240 and 241 are urged to a closed position, the cutting surfaces 240 and 241 shear the power line 20 in between the cutting surfaces 240 and 241.

In the closed position, as shown in FIG. 7, the cutting surfaces 240 and 241 contact or nearly contact each other in order to ensure complete shearing of the power line 20. In the closed position, most or all of the length of the cutting surfaces 240 and 241 are in contact or in near contact with the opposing cutting surface 240 or 241.

In the open position, the cutting surfaces 240 and 241 form the opening 243 having a “v” shape. In the fully open position, the cutting surfaces 240 and 241 are orientated at an angle of approximately 20° to approximately 40° relative to each. In other embodiments, the angle of orientation between the cutting surfaces 240 and 241 at the fully open position may range from approximately 10° to approximately 70°.

The connection of the first spring 160 and the second spring 161 will now be described. A first rod 170 is attached or integral to the first blade lever 230, while a second rod 171 is attached or integral to the second blade lever 231. The rods 170 and 171 are generally perpendicular to the orientation of the first blade lever 230 and the second blade lever 231. The first spring 160 connects to a first end 174 of the first rod 170 and to a first end 175 of the second rod 171. The second spring 161 connects a second end 176 of the first rod 170 and to a second end 177 of the second rod 171.

With reference to FIGS. 4 and 5, the first and second blade supports 305 and 306 maintain the blades 200 and 201 in position for cutting. The blade supports 305 and 306 include back surfaces 313 and 315 that press against or engage outer surfaces 204, 206 and 205, 207 of the blades 200 and 201 in a layered configuration for support and guidance during the movement of the blades 200 and 201. The blade supports 305 and 306 are generally linear members with a flattened shape having a sufficient width to support the blades 200 and 201. The first and second blade fulcrums 220 and 221 are positioned on opposite sides of the first and second blade supports 305 and 306.

The second blade support 306 is attached or integral with or connected to a curved bracket 300. With reference to FIGS. 2, 4 and 5, the curved bracket 300 joins the second blade support 306 at a bottom underneath surface 309 of the second blade support 306. A first end 317 of the curved bracket 300 is welded, joined or integral with the underneath surface 309. This positioning of the curved bracket 300 allows the first blade fulcrum 220 and the second blade fulcrum 221 to be loosened or tightened as required. The curved bracket 300 includes a sufficient angle leading away from the blade supports 305 and 306 to provide clearance for the first handle 100 and the second handle 101 to squeeze toward a closed position without interfering with or contacting the extension 50. The extension 50 and the curved bracket 300 connect to the blade support 306 and provide the connection between the operator 30 and the wire cutter 10.

From the first end 317, the curved bracket 300 includes a transition portion 320 comprising a curve or angle leading to a second end 325 having a curved bracket universal spline surface 330 that engages to a sleeve universal spline surface 340 of a sleeve 360. The sleeve 360 provides a collar or opening to receive, attach or form an integral connection with the extension 50. An adjustment nut 310 may be used to tighten or adjust the engagement between the curved bracket universal spline surface 330 and the sleeve universal spline surface 340. The universal spline surfaces 330 and 340 allow the interchange of different sticks or extensions 50. Also, the universal spline surfaces 330 and 340 allow the operator 30 to pivot the power line cutter 10 relative to the stick or extension 50.

The first blade support 305 includes a guide 400 projecting or extending from the first blade support 305. The guide 400 is generally oriented perpendicular to the first blade support 305. The guide 400 is generally oriented parallel with the extension 50. The guide 400 allows the operator 30 to catch the power line 20 to be cut anywhere on the surface of the guide 400 and walk or lead the power line 20 into the opening 243 between the first blade cutting surface 240 and the second blade cutting surface 241. The guide 400 may be approximately one or two inches to approximately six or nine inches in length, although the length of the guide 400 may vary depending on the application of the power line cutter 10. The guide 400 extends from a top surface 311 of the first blade support 305 in order to provide clearance for the operator 30 to adjust the first blade fulcrum 220 and the second blade fulcrum 221.

The first handle 100 includes a first pulley 110 positioned on the first handle 100 opposite of the blade/handle pivot 130. The first pulley 110 is attached or integral with the first handle 100 via an axle 118. The second handle 101 also includes a second pulley 111 attached or integral with the second handle 101 via an axle 119. The first pulley 110 and the second pulley 111 should be spaced a sufficient distance from the handle pivot 150 in order to achieve enough “lever” action to shear the power line 20. A distance of approximately 6 inches to approximately 36 inches is suitable for most power line applications.

The handle 100 includes an opening 105 adjacent to the first pulley 110 to allow the line 40 to be pulled by the operator 30 and for the line 40 to clear the end of the handle 100. The opening 105 provides clearance for the line 40 as the handles 100 and 200 are squeezed together. The line 40 is fastened to the first handle 100 adjacent the first pulley 110.

The line 40 then passes to the second handle 101 and around the second pulley 111. The line passes from the second pulley 111 to the first pulley 110. The line 40 is generally orientated parallel to the extension 50 in order to compress the first blade 200 and the second blade 201.

As described, the power line cutter 10 includes two pivotally engaged handles 100 and 101 that each include pulleys 110 and 111 that squeeze together when the line 40 is pulled. Both handles 100 and 101 move toward each other during actuation of the power line cutter 10. The use of the first handle 100 and the second handle 101 in the pivotal engagement provides for an improved mechanical advantage as compared to many existing devices. The improved mechanical advantage provides a greater shearing force on the cutting surfaces 240 and 241.

The extension 50 connects to the second blade support 306 in a fixed engagement with the second blade support 306. Of course, the extension 50 could alternatively connect to the first blade support 305. The second blade support 306 and the first blade support 305 are not normally moving or pivoting during the use of the power line cutter 10 in the compression of the first blade cutting surface 240 and second blade cutting surface 241. The first blade 200 and the second blade 201, as well as the first spring 160 and the second spring 161, are moving and pivoting during the use of the power line cutter 10. The first blade support 305 or the second blade support 306 provide a fixed point for the attachment of the extension 50 to the power line cutter 10. The extension 50 and the blade supports 205 and 206 remain in a constant or fixed position while the handles 100 and 101, the blades 200 and 201, etc. are moving during a shearing action of the power line cutter 10.

Moreover, the first blade support 305 and the second blade support 306 are immediately adjacent to the first blade cutting surface 240 and the second blade cutting surface 241 and the opening 243, which provides for direct movement of the cutting surfaces 240 and 241 to the contact point on the power line 20. As the extension 50 and the bracket 300 connect to the power line cutter 10 immediately adjacent to the cutting surfaces 240 and 241 and its opening 243, the movement of the extension 50 to the cutting point on the power line 20 puts the opening 243 at the cutting point. Other existing devices attach a long handle far or spaced from the actual cutting surfaces, thus making it awkward for the operator to get the cutting surfaces to the exact cutting point desired.

The first and second blades 200 and 201 are made from a hardened metal or metal alloy, such as steel, suitable for sharpening and repeatedly shearing electrical and power lines. The first and second handles 100 and 101 may be made from a rigid material suitable for transferring the pulling force from the pulleys 110 and 111. Metals, metal alloys, tubular metal, solid metal, and composite materials, such as fiberglass, may be suitable for forming the handles 100 and 101.

In other embodiments the bracket 300 and the second blade support 306 may be formed as an integral piece, i.e., a one-piece unit. Such an embodiment includes a curved bracket portion and a flattened planar portion to pivotally engage the blades 200 and 201.

It should be understood from the foregoing that, while particular embodiments of the invention have been illustrated and described, various modifications can be made thereto without departing from the spirit and scope of the present invention. Therefore, it is not intended that the invention be limited by the specification; instead, the scope of the present invention is intended to be limited only by the appended claims.

What is claimed is:

1. A power line cutter, comprising:
a first blade comprising a first blade cutting surface and a first blade lever;
a second blade comprising a second blade cutting surface and a second blade lever;
a first handle pivotally engaged to the first blade, the first handle comprising a first pulley;
a second handle pivotally engaged to the second blade, the second handle comprising a second pulley;
the first handle pivotally engaged to the second handle;
a blade support pivotally engaged to the first blade and to the second blade to pivotally position the first blade cutting surface opposite the second blade cutting surface;
a line passing from the first handle to the second pulley, the line further passing to the first pulley; and
a bracket extending from the blade support.

2. The power line cutter according to claim 1, wherein the first handle is pivotally engaged to the first blade lever and the second handle is pivotally engaged to the second blade lever.

3. The power line cutter according to claim 1, further comprising a guide extending or projecting from the blade support.

4. The power line cutter according to claim 1, further comprising a first spring and a second spring engaged to the first blade lever and to the second blade lever to urge the first blade lever and the second blade lever toward each other.

5. The power line cutter according to claim 1, wherein the first handle is pivotally engaged to the second handle at a pivot, and the first handle and the second handle pivot toward one another.

6. The power line cutter according to claim 1, wherein the blade support is pivotally engaged to the first blade at a first blade fulcrum and the blade support is pivotally engaged to the second blade at a second blade fulcrum.

7. The power line cutter according to claim 1, wherein pulling on the line causes the first and second handles to move towards each other.

8. The power line cutter according to claim 1, wherein the bracket is attached or integral to a bottom surface of the blade support, wherein the bracket has a curved shape.

9. The power line cutter according to claim 1, wherein the blade support includes a top surface and the top surface is immediately adjacent to an opening between the first blade cutting surface and the second blade cutting surface.

10. The power line cutter according to claim 1, wherein a first rod is attached to or integral with the first blade lever and a second rod is attached to or integral with the second blade lever, and a first spring connects the first rod and the second rod, and a second spring connects the first rod and the second rod.

11. The power line cutter according to claim 1, wherein the first handle includes an opening adjacent to the first pulley.

12. The power line cutter according to claim 1, wherein the first blade cutting surface and the second blade cutting surface are on an opposite side of the first blade support from springs connecting the first blade lever and the second blade lever.

13. The power line cutter according to claim 1, wherein the line passes between the first pulley and the second pulley in a generally perpendicular arrangement to an extension connected to the blade support.

14. The power line cutter according to claim 1, wherein the first blade cutting surface and the second blade cutting surface open opposite of an extension connected to the blade support.

15. The power line cutter according to claim 1, wherein the first blade cutting surface and the second blade cutting surface cut from a bottom surface of a power line.

16. The power line cutter according to claim 1, wherein the first blade cutting surface and the second blade cutting surface provide a v-shaped opening that is raised toward the power line.

17. The power line cutter according to claim 1, wherein pulling on the line causes the first handle and the second handle to compress, wherein the first handle actuates the first blade lever and the second handle actuates the second blade lever to pivot the first blade at the first blade fulcrum and the second blade at the second blade fulcrum resulting in the first blade cutting surface and the second blade cutting surface compressing together.

18. A power line cutter, comprising:
a first blade comprising a first blade cutting surface;
a second blade comprising a second blade cutting surface;
the first blade cutting surface and the second blade cutting surface forming an opening;
a first handle pivotally engaged to the first blade, the first handle comprising a first pulley;
a second handle pivotally engaged to the second blade, the second handle comprising a second pulley;
the first handle pivotally engaged to the second handle;
a blade support pivotally engaged to the first blade and to the second blade to pivotally position the first blade cutting surface opposite the second blade cutting surface;
a line passing between the first and second pulleys;
a bracket extending from the blade support; and
an end of an elongated extension connected or attached to the bracket, wherein the end of the elongated extension is adjacent the opening between the first blade cutting surface and the second blade cutting surface.

19. A power line cutter, comprising:
a first blade comprising a first blade cutting surface and a first blade lever;
a second blade comprising a second blade cutting surface and a second blade lever;
a first handle pivotally engaged to the first blade, the first handle comprising a first pulley;
a second handle pivotally engaged to the second blade, the second handle comprising a second pulley;
the first handle pivotally engaged to the second handle, wherein the first handle and the second handle are configured to both move toward each other;
a blade support pivotally engaged to the first blade and to the second blade to pivotally position the first blade cutting surface opposite the second blade cutting surface;
a line passing from the first handle to the second pulley, the line further passing to the first pulley and putting on the line moves both the handles toward each other; and
an extension connected to or integral with the blade support.

20. A power line cutter, comprising:
a first blade comprising a first blade cutting surface and a first blade lever;
a second blade comprising a second blade cutting surface and a second blade lever;
a first handle pivotally engaged to the first blade, the first handle comprising a first pulley;
a second handle pivotally engaged to the second blade, the second handle comprising a second pulley;
a first blade support and a second blade support pivotally engaged to the first blade and to the second blade to pivotally position the first blade cutting surface opposite the second blade cutting surface;
a line passing from the first handle to the second pulley, the line further passing to the first pulley;
a bracket extending from the second blade support;
a handle or stick connecting to the bracket for elevating the power line cutter; and
a guide extending from the first blade support to direct a power line into an opening between the first blade cutting surface and the second blade cutting surface.

21. A method of cutting a power line comprising:
Providing a power line cutter, the power line cutter comprising: a first blade comprising a first blade cutting surface, a second blade comprising a second blade cutting surface, a first handle pivotally engaged to the first blade, the first handle comprising a first pulley, a second handle pivotally engaged to the second blade, the second handle comprising a second pulley, the first handle pivotally engaged to the second handle, a blade support pivotally engaged to the first blade and to the second blade to pivotally position the first blade cutting surface opposite the second blade cutting surface, a line passing from the first handle to the second pulley, the line further passing to the first pulley, a stick or extension connected to the blade support;
Elevating the power line cutter;
Directing a power line to an opening between the first and the second blade;
Pulling the line; and,
Pivoting the first handle and the second handle to cause the first and second blades to cut the power line.

22. The method of cutting the power line according to claim 21, further comprising contacting the power line at a bottom surface of the power line with the first and second blade cutting surfaces.

23. The method of cutting the power line according to claim 21, further comprising guiding the powerline into an opening between the first and second blades with a guide extending or projecting from the powerline cutter.

24. The method of cutting the power line according to claim 21, further comprising elevating the power line cutter with the opening between the first and the second blades open to power line.
